(19) United States
(12) Patent Application Publication
(10) Pub. No.: US 2024/0250763 A1
(43) Pub. Date: Jul. 25, 2024

(54) INTERFERENCE IDENTIFICATION IN A RAN

(71) Applicant: EXFO Solutions SAS, Saint-Jacques de la Lande (FR)

(72) Inventors: Xanthos Nicolaos ANGELIDES, Madrid (ES); María José DOMÉNECH BENLLOCH, Moncada (ES); María Vicenta CASTILLO IBÁÑEZ, Valencia (ES); Javier SÁEZ AMORÓS, Castellón (ES); Juan José RUBIO ESTEBAN, Valencia (ES); Eduardo PALOMERO LÓPEZ, Valencia (ES)

(73) Assignee: EXFO Solutions SAS, Saint-Jacques de la Lande (FR)

(21) Appl. No.: 18/410,254

(22) Filed: Jan. 11, 2024

Related U.S. Application Data
(60) Provisional application No. 63/439,898, filed on Jan. 19, 2023.
(60) Provisional application No. 63/443,941, filed on Feb. 7, 2023.

(51) Int. Cl. H04B 17/345; H04W 24/10

(52) U.S. Cl. CPC H04B 17/345; H04W 24/10

(57) ABSTRACT

An interference matrix for LTE and NR based on user equipment measurement data reports for PCI clash and neighbor addition and deletion algorithms. In an embodiment, a method for identifying interferences in a telecommunications network having at least one serving cell and at least one reported cell includes retrieving data sources including one or more of (a) call trace data from the telecommunications network and (b) device metrics from multiple user equipment (UEs) connected to a telecommunications network; processing the data sources to form an interference matrix with structured data that is vendor and device agnostic by (a) parsing and correlating the call trace data to provide the structured data and (b) processing the device metrics from multiple UEs and geo-binning them based on location; analyzing the structured data in the interference matrix to determine interferences between cells; and displaying information about the determined interferences.

### CROSS-REFERENCE TO RELATED APPLICATION(S)

The present disclosure claims priority U.S. Provisional Patent Application No. 63/439,898, filed Jan. 19, 2023, and U.S. Provisional Patent Application No. 63/443,941, filed Feb. 7, 2023, the contents of each are incorporated by reference in their entirety.

### FIELD OF THE DISCLOSURE

The present disclosure relates generally to wireless networking. More particularly, the present disclosure relates to systems and methods for interference identification in a Radio Access Network (RAN), i.e., automatic diagnosis for RAN issues, focused on cells.

### BACKGROUND OF THE DISCLOSURE

In 4G, wireless networks included evolved Node B (eNB) cells, and, in 5G, these cells are next generation Node B (gNB) cells. Of note, there are a larger number of gNB cells in 5G than eNB cells in 4G, i.e., Long Term Evolution (LTE), and network complexity is higher in 5G, such as due to network slicing, private networks, satellite communication, etc. With the rollout to 5G, a higher degree of automation in RAN operations is expected and required, relative to the automation in 4G, including planning and optimization for network management. To address market needs, RAN data must be processed efficiently to generate automated changes in the network. The way the standards (3GPP, ORAN, TIP, etc.) are defining these network automations is that there should be individual analysis, called algorithms, use cases, xApps or rApps, depending on the environment. For example, an rApp is designed to run on the Non-Real-Time RAN Intelligent Controller (RIC) to realize different RAN automation and management use cases, with control loops on a time scale of one second and longer.

Prior art RAN planning tools use matrices at the design/planning of networks based on mathematical/statistical theoretical Radio Frequency (RF) propagation models (such as the Okumuara Hata model, for example). These models estimate the power received by each antenna on every bin/tile in a map. Based on these models, designers identify the best serving cell for each area and how important are the other contributors on the area. All these calculations are estimations, not based on real live data.

There is a need to provide algorithms to identify interference issues in the network with live network data to support automation in the operation phase of the network management.

### BRIEF SUMMARY OF THE DISCLOSURE

The present disclosure relates to systems and methods for interference identification in a Radio Access Network (RAN), i.e., automatic diagnosis for RAN issues, focused on cells. The present disclosure includes techniques to build an interference matrix based on live call trace data (user equipment measurement data reports) and probes embedded within user equipment (e.g., mobile agents collecting on demand mobile device measurement, performance and serving cell metrics), or tapping of network interfaces to then identify interference issues. Interference issues may include Accessibility Failures, Packet Loss, Physical layer Cell Identifier (PCI) clash, Root Sequence Index (RSI) overlap and neighbor addition and deletion issues.

In an embodiment, a method for identifying interferences in a telecommunications network having at least one serving cell and at least one reported cell includes retrieving data sources including one or more of (a) call trace data from the telecommunications network and (b) device metrics from multiple user equipment (UEs) connected to a telecommunications network; processing the data sources to form an interference matrix with structured data that is vendor and device agnostic by (a) parsing and correlating the call trace data to provide the structured data and (b) processing the device metrics from multiple UEs and geo-binning them based on location; analyzing the structured data in the interference matrix to determine interferences between cells; and displaying information about the determined interferences.

One aspect of the present disclosure provides techniques for the automatic diagnosis of RAN issues, these algorithms relying on an interference matrix (IFMX) based on real call trace data from live networks or device metrics collected from probes embedded in User Equipment connected to the live network. The call trace data and device metrics are used to populate an interference matrix which then allows to carry out the algorithms more directly and efficiently. The techniques allow to identify the best serving cell and how many other contributors are in the area and the real signal strength there for each one.

Another aspect of the present disclosure provides a methodology to generate an interference matrix calculated based on the user equipment measurement reports (MR) and/or related metrics. A parser element captures and reads the message flow of LTE call traces from any vendor, despite different vendor formats, and delivers the captured data in specific messages called measurement reports. It uses the information within MR to identify those reported cells with higher importance. It is completed with more information extracted from trace data, such as handover information when cells are defined as neighbors in the system. Number of MR where a reported cell is present for specific serving cell is used as footprint overlapping metric. MR also provides specific signal strength (RSRP) of each reported cell as well as serving, so it allows to compare magnitudes of serving cell RSRP and its reported cells. The interference matrix methodology establishes thresholds for planning rules-based interference identification. The interference matrix methodology delivers additional calculations to identify PCI clashes, RSI overlap, external Interference, missing neighbors, and unused neighbors.

Another aspect of the present disclosure provides a methodology to generate an interference matrix calculated based on the Mobile Device Information and/or related metrics. A processing element captures and reads the Device Metrics from any UE vendor, despite different vendor formats, and delivers the captured data in specific messages called Device Records. Multiple device records are then grouped based time intervals and based on the reported device location into geo-bins of defined size, e.g., 10 m₂ or 50 m², to generate records of correlated cells serving a defined geo-bin and their related metrics. For simplicity these grouped records will also be referred to as Measurement Reports (MR). The processor uses the information within the generated MR to identify those reported cells with higher importance. The processing is completed with more information extracted from raw data or enriched from other sources such as network topology or handover information when cells are defined as neighbors in the system. Number of MR where a reported cell is present for specific serving cell is used as footprint overlapping metric. MR also provides specific signal strength (RSRP) of each reported cell as well as serving, so it allows to compare magnitudes of serving cell RSRP and its reported cells. The interference matrix methodology establishes thresholds for planning rules-based interference identification. The interference matrix methodology delivers additional calculations to identify PCI clashes, RSI overlap, external Interference, missing neighbors, and unused neighbors.

Still another aspect of the present disclosure is to generate an interference matrix (IFMX) calculated based on the user equipment measurement reports (MR), the Device Metrics generated MRs and related metrics to identify interferences between cells in network. A parser captures and reads the message flow of LTE call traces from any vendor and delivers the data. Likewise, a processor collects processes and geo-bins captured user equipment mobile measurements from any user equipment vendor to generate measurement reports (MR). The reported cells with higher importance are then identified. It allows an engine to compare magnitudes of serving cell RSRP and its reported cells. The engine uses the interference matrix to deliver additional calculations to identify PCI clashes, RSI Overlap, external Interference, missing neighbors, and unused neighbors.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a flowchart of a process for building an interference matrix based on live call trace data to then identify interference issues.

FIG. 2 is an example handover/interference matrix aggregation.

FIG. 3A is a flowchart of a RAN Quality of Service (QOS)-based resource optimization process.

FIG. 3B is a graph of downlink (DL) and uplink (UL) volume after using the resource optimization process.

FIG. 3C is a graph of DL and UL User Equipment (UE) bandwidth after using the resource optimization process.

FIG. 4 is a flowchart of a process for identifying interferences in a telecommunications network having at least one serving cell and at least one reported cell.

FIG. 5 is a block diagram of a processing system, which may be used to implement the process of FIG. 4.

### DETAILED DESCRIPTION OF THE DISCLOSURE

Again, the present disclosure relates to systems and methods for interference identification in a Radio Access Network (RAN), i.e., automatic diagnosis for RAN issues, focused on cells. The present disclosure includes techniques to build an interference matrix based on live call trace data (user equipment measurement data reports) and probes embedded within user equipment (e.g., mobile agents collecting on demand mobile device measurement, performance and serving cell metrics) or tapping of network interfaces to then identify interference issues. Interference issues may include Accessibility Failures, Packet Loss, Physical layer Cell Identifier (PCI) clash, Root Sequence Index (RSI) overlap and neighbor addition and deletion issues.

### Process

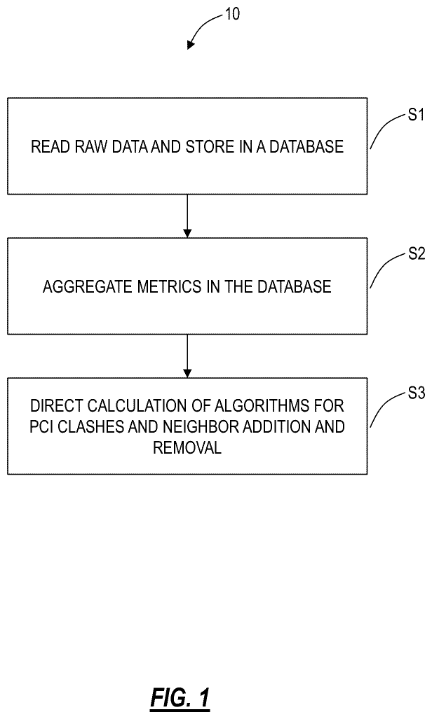

FIG. 1 is a flowchart of a process 10 for building an interference matrix based on live call trace data or Device Metrics collected from User Equipment to then identify interference issues. The process 10 contemplates implementation as a method having steps, via a processing device configured to implement the steps, via a cloud service configured to implement the steps, and/or as non-transitory computer-readable medium with instructions that, when executed, cause one or more processors to implement the steps. In an embodiment, the process 10 is implemented by a RAN parser, or simply parser. A RAN Data Processing System (also referred to herein as a Parser, a RAN parser, a parsing agent, and a processor) is a scalable software adapter which collects and processes 2G, 3G, 4G and 5G 3rd Generation Partnership Project (3GPP) and vendor-specific RAN call events to generate records and, optionally geolocated call records and real time location insights. Furthermore, a processor can collect user equipment measurements collected by a probe and extract vendor specific measurements including the location of the device.

At a first step S1, a parser reads the raw data and delivers results into a database. The parser can extract measurement report metrics from Message Flow or Device Records and aggregate data at 1) serving cell level and 2) reported cell level. The parser reads the input data and accounts for all these metrics. It also incorporates handover metrics from other sources than measurement report messages. It also can process topology data, physical topology data (location coordinates, antenna azimuth, etc.) and configuration management data (vendor dependent), to provide cell identification, parameters, number of defined neighbors and calculated distances. In the case of Device Records where only the serving cell is reported, the location information of the user equipment is used to group multiple measurements from different devices within a geographical bin size to define a set of serving and reported cell relations referred to as a Measurement Report (MR).

The parser is addressing the raw data processing and delivery of structured data that serves as basis for algorithm processing. In order to have all the required data for the interference identification techniques, the parser delivers data, and the database aggregates it in what is called herein an Interference Matrix (IFMX). The individual algorithms are then executed to provide the conclusions and recommendations. For example, direct calculation of algorithms for PCI clashes, RSI Overlaps, and Neighbor addition and removal can be performed.

The parser reads the call trace raw data, processes it and generates the output which is ingested in database. The raw data is vendor dependent, binary format, and parser is able to read from various different equipment vendors (for example, Ericsson, Nokia, Huawei, ZTE, Samsung, Corning, etc.) and mobile device vendors (for example Android, IOS, Linux, etc.).

The parser reads physical data like location coordinates and antenna azimuth. In one embodiment, the customer provides the data in Comma Separate Value (CSV) or txt format with a specific pre-defined header. This data includes node coordinates and antenna azimuth which are used for 1) geolocate each call in the trace data and 2) visualize results and build heat maps on top of the application.

The parser reads configuration management (CM) data, which are cell parameters in a vendor specific format. There is a list of parameters that are obtained from different vendors and the parser applies some calculations in order to standardize between all vendors to produce vendor-independent final values. The Configuration Management (CM) data contains value for cell and node level configuration parameters that can impact on the RF propagation. This data is used to identify cells in the measurement reports. MR do not contain cell names or IDs, but only carrier (frequency) and PCI, so a correlation with the processed CM data is carried out to properly identify cells in measurement reports. On the other hand, mobile device records contain the cell identifier which also needs to be mapped to the relevant cell names. This allows to calculate several metrics such as the number of measurements per cell on each bin, which one is the server for each call and handover metrics for cells defined as neighbors or metrics collected from distinct user equipment within the same bin area.

The parser can generate one or multiple outputs (topics) from all these information sources, as follows:
Topology data: the parser correlates physical data with processed CM data and gets a list of parameters at cell and neighbor levels. This is known as topology data. The number of neighbors per neighbor type (intra/inter system, intra/inter frequency) can also be calculated.
Measurement report data: Parser uses topology data to identify cells in MR. In raw data, there is only information of the frequency and the PCI. The parser correlates that information with topology data to identify reported cells in MR. For each MR, it determines which cells are reported and the reported Reference Signal Received Power (RSRP) level. It also determines the RSRP and Reference Signal Received Quality (RSRQ) of the reference cell. With this information, it calculates the RSRP difference between the reference cell and each one of the reported cells for each MR. Timing advance metrics are aggregated as well.
Handover information: similar to MR, when a handover event is read in the raw data, the parser gets the information of source cell (reference cell) and target cell (reported cell) and if handover was successful or not.
Mobile Device Data: Processor uses topology data to identify cells in device records. In raw data, there is only information of the cell ID. The processor groups multiple device records-based time intervals and based on the reported device location into geo-bins of defined size e.g. 10 m² or 50 m² to generate records of correlated cells serving a defined geo-bin and their related metrics. For simplicity these grouped records will also be referred to as Measurement Reports or MR. For each MR, it determines which cell is the reference cell being the cell with the strongest Reference Signal Received Power (RSRP) level and the remaining cells are considered as reported cells with their equivalent Reference Signal Received Power (RSRP) level. It also determines the RSRP, Reference Signal Received Quality (RSRQ) and Signal to Interference and Noise Ratio (SINR) of each cell. With this information, it calculates the RSRP difference between the reference cell and each one of the reported cells located by GPS withing the same bin area.

At a second step S2, the process 10 includes aggregation of metrics in database. Using the outputs (topics) described above, the aggregation engine correlates and aggregates this data:
Serving cell (also called Reference cell):
   Number of MR where reference cell is serving cell.
   Total number of MR where reference cell has been found (as serving or reported or reference cell with highest signal level)
   Timing Advance histogram (applicable to call trace)
   Number of outgoing handover attempts and successes (applicable to call trace)
   Average RSRP
   Average RSRQ
   Average SINR (applicable to Mobile Device Records)
Reported cell:
   Number of MR where reported cell has been found for the specific serving or reference cell.
   Number of handover attempts and successes from specific reference cell to each reported cell (applicable to call trace and only applies to neighbor cells)
   Average RSRP in the serving cell-reported cell overlapped area.
   Difference between serving cell RSRP and reported cell RSRP in the overlapped area.
Topology parameters:
   Serving and reported cell basic CM and physical parameters.
   Accounting for reference cell's number of neighbors (intra/inter system, intra/inter frequency, etc.)
   Serving cell-reported cell relation parameters
   Distance between serving cell and each of reported cells.

The aggregation engine can use the output that parser produces and delivers into the database and aggregates all these metrics into tables at specific granularity. The parser can deliver data at a predefined frequency, for example, every 5 or 10 minutes, and the aggregation engine adds the data to the last available record until the predefined granularity (daily by default). When the period has ended and a new period begins, the aggregation engine generates new input and starts process again.

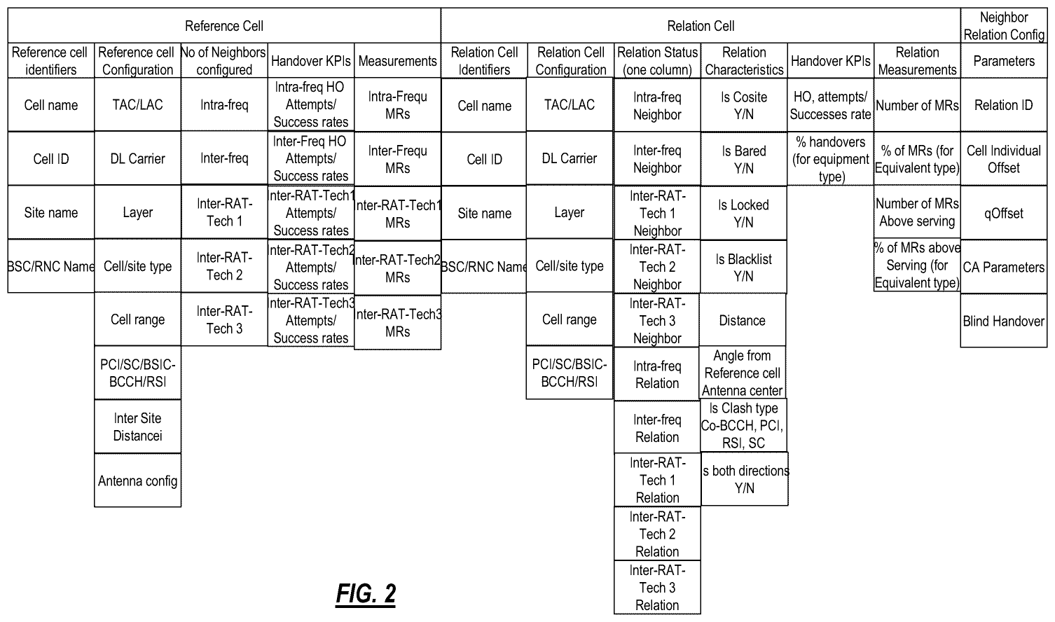

FIG. 2 is an example handover/interference matrix aggregation. The results per interferer detected in MRs provide distribution/matrix based on MRs/Handoffs (HOs). For the Reference Cell, the table shows the reference cell identifiers, the reference cell configuration, the number of configured neighbors, the handover KPIs and the measurements. For the Relation Cell, the table shows relation cell identifiers, the relation cell configuration, the relation status, the relation characteristics, the handover KPIs and the relation measurements. For the Neighbor Relation Configuration, the parameters are shown.

### Example Metric Calculation

The IFMX contains information of:
Serving cell (also called Server or Reference cell):
   MR_{ref,total,i} Number of MR where reference cell is serving cell for cell i.
   MR_{total,i} Total number of MR where reference cell has been found (as serving or reported)
   Timing Advance histogram, allowing to get Timing Advance for x^{th} percentile: TAᵢ^{xth} (applicable to call trace)
   Number of outgoing handover attempts and successes, HO_{i,att} and HO_{i,suc} (applicable to call trace)
   Average RSRP, Avg_RSRPᵢ
   Average RSRQ, Avg_RSRQᵢ
   Average SINR, Avg_SINRᵢ (applicable to Mobile Device Records)
Reported cell:
   MR_{i,j} Number of MR where reported cell j has been found for the specific serving cell i.
   HO_{i,j,att} and HO_{i,j,suc} Number of handover attempts and successes from specific reference cell to each reported cell (only applies to neighbor cells and to call trace)
   Average RSRP in the serving cell-reported cell overlapped area, Avg_RSRPⱼ₍ᵢ₎
   Difference between serving cell RSRP and reported cell RSRP in the overlapped area, Avg_RSRP_{diff-i,j}.
Topology parameters:
   Serving and reported cell basic CM and physical parameters.
   Accounting for reference cell's number of neighbors (intra/inter system, intra/inter frequency, etc), Number of Bearers (NBR)—NBR_{total,i}, NBR_{intrat,i}, NBR_{interf,i}, NBR_{5G,i}, NBR_{4G,i}
   Serving cell-reported cell relation parameters
   Distance between serving cell and each of reported cells, Distance_{i,j}.

Each User Equipment (UE) is geolocated when in connected mode (call ongoing) through MR and coordinates of surrounding cells. One MR can be in the form:

Cellᵢ RSRPᵢ, RSRQᵢ; PCIⱼ RSRPⱼ, PCIₖ RSRPₖ, PCIₗ RSRPₗ, . . . etc

Where i stands for the serving cell and reported cells are j, k, l, etc.

In the case of Mobile Device records, the User Equipment (UE) provides the location information in both connected and idle mode and is used directly in the grouping of distinct devices to generate measurement reports. One MR can be in the form:

Cellᵢ RSRPᵢ, RSRQᵢ; Cellⱼ RSRPⱼ, Cellₖ RSRPₖ, Cellᵢ RSRPₗ, . . . etc

Where i stands for the serving cell and reported cells are j, k, I, etc.

In relation to call trace data, the Measurement report does not identify cells. The UE can be geolocated using triangulation method.
With all MR for the serving cell i and the Timing Advance reported by the UE, it is built the cell footprint with average RSRP per distance.
With UE reporting TA x and RSRPᵢ, there is a radius where UE could be located using the footprint, Radiusᵢ.
Using highest RSRP within the reported cells in MR and the footprint for such cell j, there is another radius where the UE could be located, Radiusⱼ.
Using second highest RSRP within the reported cells in MR and the footprint for such cell k, there is another radius where the UE could be located, Radiusₖ.
Intersection of the three radius, Radiusᵢ, Radiusⱼ and Radiusₖ gives the exact location of the UE at a given time.

Calculated footprints for given time are stored for the next time slot geolocation calculation and thus using these footprints in next calculations. Using the location of the UE, cells in MR are identified using the PCI and the frequency for which they are reported: cell j is the one with PCIⱼ and closest to the UE location.

So, calculation for each metric is as follow:

Serving Cell level metrics:
MR_{ref,total,i}—accounting for all MR where cell i is identified as serving or reference cell.
MR_{total,i}—accounting for all MR where cell i is identified, either as serving or reference or as reported.
TAᵢ^{xth}—accounts as histogram for all reported Timing Advance for cell I (applicable to call trace)
HO_{i,att}—accounts for all Handover attempt messages for serving cell i (applicable to call trace only)
HO_{i,att}—accounts for all Handover complete messages for serving cell i.
Avg_RSRPᵢ—averages all RSRP measurements in MR for cell i when cell i is identified as serving or reference cell.
Avg_RSRQᵢ—averages all RSRQ measurements in MR for cell i when cell i is identified as serving or reference cell.
Avg_SINRᵢ—averages all SINR measurements in MR for cell i when cell i is identified as serving or reference cell (applicable to Mobile Device Records)

Reported Cell level metrics:
MR_{i,j}—accounting for all MR where cell i is identified as serving cell and cell j is identified as reported cell.
HO_{i,j,att}—accounts for all Handover attempt messages for serving cell i when cell j is target cell (applicable to Mobile Device Records)
HO_{i,j,suc}—accounts for all Handover complete messages for serving cell i when cell j is target cell (applicable to Mobile Device Records)
Avg_RSRPⱼ₍ᵢ₎—averages all RSRP measurements in MR for cell j when cell i is identified as serving cell.
Avg_RSRP_{diff-i,j})—for each MR, it is calculated RSRPᵢ−RSRPⱼ₍ᵢ₎ and then averaged for all MR where cell i is identified as serving cell and cell j is identified as reported cell.
Avg_SINR_{diff-i,j})—for each MR, it is calculated SINRᵢ−SINRⱼ₍ᵢ₎ and then averaged for all MR where cell i is identified as serving cell and cell j is identified as reported cell (applicable to Mobile Device Records)

Topology parameter calculations
NBR_{total,i}—accounts for all cells defined as neighbors in CM data for cell i.
NBR_{intraf,i}—accounts for all cells defined as neighbors in CM data for cell i where the carrier of the neighbor is the same as the carrier of cell i and the technology (4G, 5G) is the same.
NBR_{interf,i}—accounts for all cells defined as neighbors in CM data for cell i where the carrier of the neighbor is different than the carrier of cell i and the technology (4G, 5G) is the same.
NBR_{5G,i}—accounts for all cells defined as neighbors in CM data for cell i when cell i is a 4G cell and neighbor are 5G.
NBR_{4G,i}—accounts for all cells defined as neighbors in CM data for cell i when cell i is a 5G cell and neighbor are 4G.
Distance_{i,j}—using cell coordinates, it is calculated the distance in meters between serving or reference cell i and all reported cells j.

At step S3, the process 10 includes a direct calculation of algorithms for PCI clashes and Neighbor addition and removal. Data described in previous step contain the basic information to execute all the basic algorithms (PCI clashes, ANR (neighbor addition and deletion), Overshooters and Cross-sectors) as well as more advanced ones (Downlink Power Optimization).

PCI Clashes—Interference matrix allows to identify PCI clashes for the same technology (LTE, 5G New Radio (NR)) cells within the same carrier. There is direct observability for clashing in serving cells with reported cells with the same PCI. This methodology is not limited to existing neighbors in the system, but also covers cells with certain degrees of overlapping.

Additionally, the second order reported cells are processed as follows:
Serving or reference cell—reported cells table is instanced twice.
Second instance for the table is linked with first instance.
Reported cell in first instance is correlated with serving cell in second instance.
Result is visibility for second order reported cells.

Using this set of data, and filtering for the same technology and same carrier cells, the system determines the following conclusions:
PCI collision between serving cell Sc and reported cell Rcᵢ.
PCI confusion between any reported cells Rc_{i,j} of the same serving cell Sc
PCI confusion between serving cell Sc and any second order reported cell RRcᵢ.
PCI confusion between any reported cell Rcᵢ of specific serving cell Sc and any other second order reported cell RRcᵢ.
PCI confusion between 2 serving cells Scᵢ and Scⱼ with a common reported cell Rcᵢ.
a PCI collision between two cells Scᵢ and Scⱼ serving two or more distinct devices located with a small distance from each other, i.e., 10 m² or 50 m².

Additionally, another level of processing can be added to identify 3^{rd} order reported cells with the same approach as the 2^{nd} order.

There are planning rule thresholds to define percentage of overlapping, RSRP level of the reported cell and RSRP difference between serving and reported cells. Matching these rules, the engine can identify 1) serving cells with high number of interferers and/or poor RSRP difference (lack of dominance) and 2) reported cells that are causing interference unnecessarily.

### Example Calculation

PCI clashes are obtained directly from the Serving cell—reported cells table. Primary key for this table is the couple Serving cell i—reported cell j. So, there is one record for each couple:

$${Cell}_{i} - {Cell}_{j}$$

Direct clashes where same PCI, same carrier (ARFCN) is used on both Cell i and Cell j is detected:

$$P C {I}_{i} = P C {I}_{j}$$

$$AND$$

$$A R F C {N}_{i} = A R F C {N}_{j}$$

Second order clashes are detected with two instances of the same table, serving cell—reported cells table, so each reported cell Cell j in first instance is linked with each serving cell Cell i in second instance:

$${Cell}_{j , instance 1} = {Cell}_{i , instance 2}$$

And thus, having a data structure with the following tuple as primary key:

$${Cell}_{i , instance 1} - {Cell}_{j , instance 1} - {Cell}_{j , instance 2}$$

Where Cell j from second instance are reported cells for each Cell j from first instance.

Then, the following cases can be supported:
Direct clashes:
   PCI collision between serving cell Sc and reported cell Rcᵢ.
   PCI confusion between any reported cells Rc_{i,j} of the same serving cell Sc

$$P C {I}_{k} = P C {I}_{l}$$

$$AND$$

$$A R F C {N}_{k} = A R F C {N}_{l}$$

where k, l∈Cell; within same Cellᵢ
PCI confusion between 2 serving cells Scᵢ and Scⱼ with a common reported cell Rcᵢ.

$$P C {I}_{i} = P C {I}_{i} ,$$

$$AND$$

$$A R F C {N}_{i} = A R F C {N}_{i} ,$$

where Cellᵢ and Cellᵢ, have common Cellⱼ
Second order clashes
   PCI confusion between serving cell Sc and any second order reported cell RRcᵢ.

$$P C {I}_{i , instance 1} = P C {I}_{j , instance 2}$$

$$AND$$

$$A R F C {N}_{i , instance 1} = A R F C {N}_{j , instance 2}$$

where Cell_{i,instance 1} and Cell_{j,instance 2} have common Cell_{j, instance 1}
PCI confusion between any reported cell Rcᵢ of specific serving cell Sc and any other second order reported cell RRcᵢ.

$$P C {I}_{j , instance 1} = P C {I}_{j , instance 2}$$

$$AND$$

$$A R F C {N}_{j , instance 1} = A R F C {N}_{j , instance 2}$$

where Cell_{j,instance 1} and Cell_{j,instance 2} have common Cell_{i,instance 1}
   Identification of Reported Cells that should be Defined as Neighbors (ANR Addition)

Using planning rule thresholds for the minimum amount of MR and the minimum required RSRP enables the identification of reported cells that are not defined currently as neighbors, but they have the requirements to be defined as such.

### Example Algorithm Calculation

Using planning rules threshold for minimum amount of MR (MRₘᵢₙ) and minimum required RSRP (RSRPₘᵢₙ) enables the identification of reported cells that are not defined currently as neighbors, but they have the requirements to be defined.

This is obtained directly from the Serving cell—reported cells table, where reported cells are identified as neighbor when correlating data with CM data:
For each pair Cellᵢ−Cellⱼ not defined as neighbour
   If MR_{i,j}≥ MRₘᵢₙ AND AVG_{RSRP}_{ⱼ₍ᵢ₎}≥RSRPₘᵢₙ
      Then add Cell; as neighbour for Cellᵢ
         Identification of Neighbor Cells that should not be Defined as Neighbors in the System (ANR Deletion)

Using the handover metrics defined above and planning rule thresholds for the maximum amount of handover attempts in the measurement period and minimum handover success rate for that neighbor cell, the engine is able to identify neighbor cells that do not match the requirements to keep them as neighbor cells in the system.

In one embodiment, the IFMX and/or the algorithm result is displayed as a report in a Graphical User Interface (GUI). In one embodiment, the IFMX and/or the algorithm result is displayed as a map in the GUI.

### Example Algorithm Calculation

Using the handover metrics defined and planning rules threshold for maximum amount of handover attempts (HOₘₐₓ) in the measurement period and minimum handover success rate (HOSRₘᵢₙ) for that neighbor cell enables the identification of neighbor cells that do not match the requirements to keep them as neighbor cells in the system. This is obtained directly from the Serving cell—reported cells table, where reported cells are identified as neighbor when correlating data with CM data:
For each pair Cellᵢ−Cell; defined as neighbour
If

$${HO}_{i , j , att} \leq {HO}_{m ax}$$

$$AND$$

$$\frac{{HO}_{i , j , succ}}{{HO}_{i , j , att}} \leq {HOSR}_{m i n}$$

Then remove Cell; as neighbour for Cellᵢ

### Live Data IFMX

The IFMX is based on real measurements from the network. The best serving cell and how many other contributors in the area and the real signal strength there are for each one are determined. To achieve this, several data sources are parsed/processed and correlated. The matrix is a representation of all customers actual traffic and how the customer interacts with the network elements. The complexity is to extract from every measurement reported by handsets, information of the specific network elements and their KPIs reported. This includes a massive amount of data (billions of data records) which are continuously extracted, correlated and aggregated. To this gathered data, a correlation with further metrics is done and parameters are extracted from other data inputs—call events, network configuration and network topology. Being able to extract and correlate the combination of the data at the volumes in use is the biggest challenge which this methodology and system address.

There is no use of a carrier over interference ratio, C/I. The event MR are irrelevant. Neighbor cells are identified with geolocation and CM data cross correlation with MR. The data is at reference cell-reported cell level, no aggregation at reference cell level for interference measurements. The calculations are based on number of MR, average signal strength and HO metrics (if reported cell is neighbor). MR is used as bulk data, with no detail on the LTE events.

### Example

A Quality-of-Service (QOS)-based resource optimization algorithm is a practical implementation of the IFMX described herein. It allows to combine the consideration of multiple actions that could solve problems that have a specific characteristic.

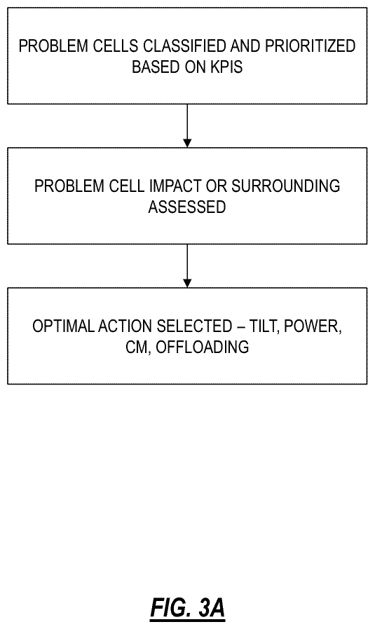

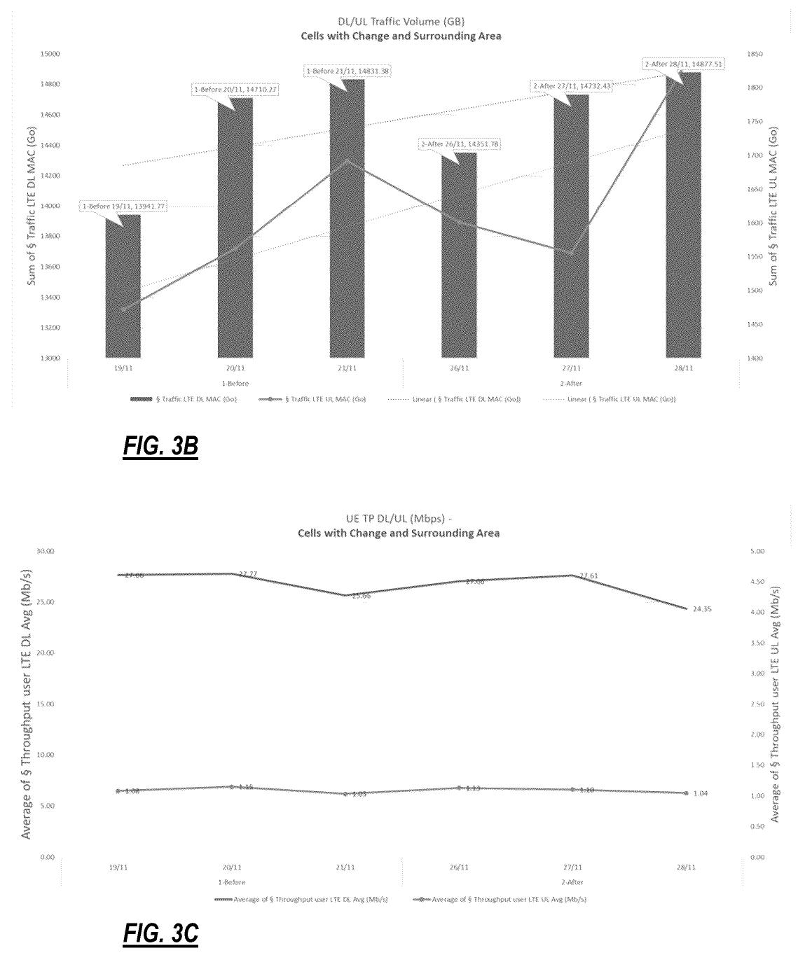

FIG. 3A is a flowchart of a RAN Quality of Service (QOS)-based resource optimization process. FIG. 3B is a graph of downlink (DL) and uplink (UL) volume after using the resource optimization process. FIG. 3C is a graph of DL and UL User Equipment (UE) bandwidth after using the resource optimization process.

FIGS. 3A-3C illustrate a resent use case where the algorithm automatically classified specific cells suffering from combinations of performance, interference, coverage and capacity issues in a first step. Then, in subsequent steps, the possible solutions are assessed in terms of viability and impact they may have on the overall QoS and impact on elements in the surrounding area to choose the best fit of solution from a set of actions (tilt, power, etc.). The methodology enables addition of further problem classifications and also further actions to expand to further needs.

### Process

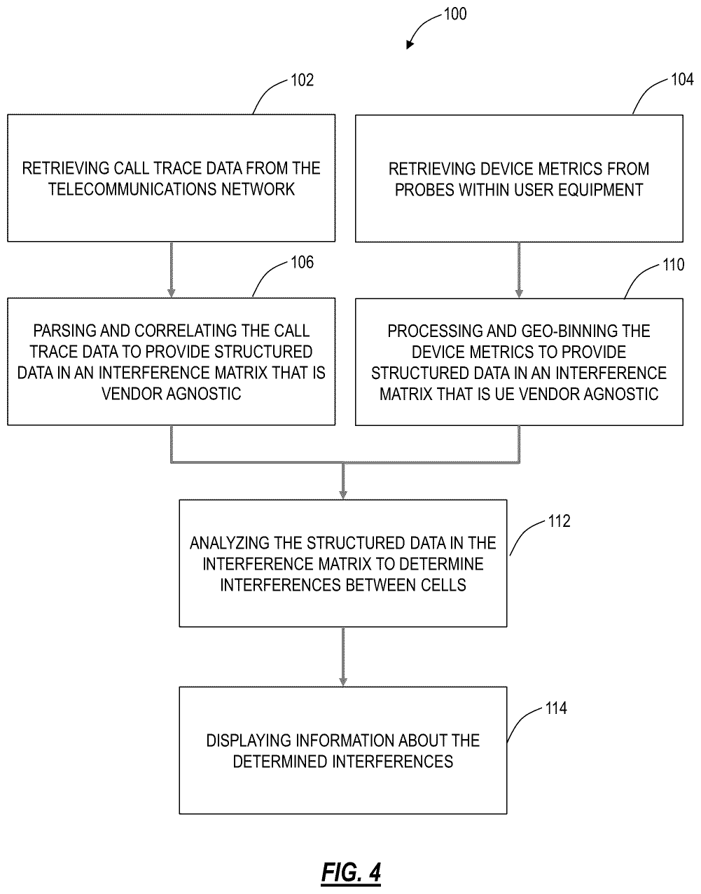

FIG. 4 is a flowchart of a process 100 for identifying interferences in a telecommunications network having at least one serving cell and at least one reported cell. The process 100 contemplates implementation as a method having steps, via a processing device configured to implement the steps, via a cloud service configured to implement the steps, and/or as non-transitory computer-readable medium with instructions that, when executed, cause one or more processors to implement the steps.

The process 100 includes retrieving data sources including one or more of (a) call trace data from the telecommunications network and (b) device metrics from multiple user equipment (UEs) (e.g., from probes) connected to a telecommunications network (steps 102, 104); processing the data sources to form an interference matrix with structured data that is vendor and device agnostic by (a) parsing and correlating the call trace data to provide the structured data and (b) processing the device metrics from multiple UEs and geo-binning them based on location (steps 106, 108); analyzing the structured data in the interference matrix to determine interferences between cells (step 110); and displaying information about the determined interferences (step 112).

The call trace data or the device metrics can include measurement data, physical information, and configuration management data. The physical information can include handover information and the configuration management data includes topology data. The location can be based on a reported location within the device metrics, e.g., latitude and longitude, and the geo-binning is a grouping of individual device metrics during a period of time and based on a fixed bin size.

The determined interferences can be Physical layer Cell Identifier (PCI) clashes. The PCI clashes can include at least one of:
a PCI collision between serving cell and reported cell;
a PCI confusion between any reported cell of the same serving cell;
a PCI confusion between a serving cell and any second order reported cell;
a PCI confusion between any reported cell of a specific serving cell and any other second order reported cell;
a PCI confusion between two serving cells with a common reported cell; and
a PCI collision between two cells serving two or more distinct devices located with a fixed distance from each other, e.g., 10 m² or 50 m².

The parsing and correlating or the processing can include classifying the cells by technology and by carrier. The process 100 can further include retrieving at least one planning rule threshold, wherein the planning rule threshold is one of a percentage of overlapping, a minimum amount of data points, a minimum required Reference Signal Received Power (RSRP) level of the reported cell, a minimum handover success rate for a neighbor cell and a maximum number of handover attempts in a measurement period. The process 100 can further include identifying a cell from the telecommunications network to be a neighboring cell to another cell of the telecommunications network using the planning rule threshold and providing a neighbor addition report to the telecommunications network including information about the identified cell. The process 100 can further include determining a cell from the telecommunications network to be falsely identified as a neighboring cell to another cell of the telecommunications network using metrics of the interference matrix and providing a neighbor deletion report to the telecommunications network including information about the determined cell, wherein the falsely identified cell has less measurements than the minimum expected measurements. The falsely identified cell does not meet the minimum handover success rate for a neighbor cell.

The process 100 can further include identifying problematic cells within the network, wherein the problematic cells are at least one of a serving cell with a high number of associated interferences, a serving cell with poor Reference Signal Received Power (RSRP) difference (lack of dominance) and a reported or correlated cell which is causing unnecessary interference. The determining interferences can include identifying reported cells with a higher importance using the structured data. The identifying can include calculating a footprint overlapping metric using (a) a number of measurement reports in which a reported cell is present for a specific serving cell or (b) a number of device metrics where various cells are present within a reporting period and location bin area. The determining interferences can include comparing magnitudes of a Reference Signal Received Power (RSRP) of each reported cell and serving cell.

### Processing System

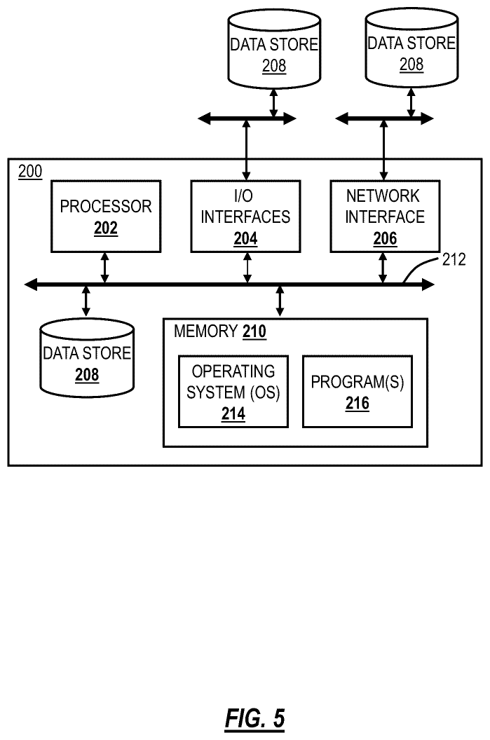

FIG. 5 is a block diagram of a processing system 200, which may be used to implement the process 100. The processing system 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 9 depicts the processing system 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the processing system 200, a semiconductor-based microprocessor (in the form of a microchip or chipset), or generally any device for executing software instructions. When the processing system 200 is in operation, the processor 202 is configured to execute software stored within the memory 210, to communicate data to and from the memory 210, and to generally control operations of the processing system 200 pursuant to the software instructions. The I/O interfaces 204 may be used to receive user input from and/or for providing system output to one or more devices or components.

The network interface 206 may be used to enable the processing system 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 208 may incorporate electronic, magnetic, optical, and/or other types of storage media. In one example, the data store 208 may be located internal to the processing system 200, such as, for example, an internal hard drive connected to the local interface 212 in the processing system 200. Additionally, in another embodiment, the data store 208 may be located external to the processing system 200 such as, for example, an external hard drive connected to the I/O interfaces 204 (e.g., SCSI or USB connection). In a further embodiment, the data store 208 may be connected to the processing system 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

In an embodiment, one or more processing devices 200 can be configured in a cluster and/or in a cloud system, for implementing the process 100. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

### CONCLUSION

It will be appreciated that some embodiments described herein may include one or more generic or specialized processors (“one or more processors”) such as microprocessors; central processing units (CPUs); digital signal processors (DSPs): customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a read-only memory (ROM), a programmable read-only memory (PROM), an erasable programmable read-only memory (EPROM), an electrically erasable programmable read-only memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A method for identifying interferences in a telecommunications network having at least one serving cell and at least one reported cell, the method comprising steps of:
retrieving data sources including one or more of (a) call trace data from the telecommunications network and (b) device metrics from multiple user equipment (UEs) connected to a telecommunications network;
processing the data sources to form an interference matrix with structured data that is vendor and device agnostic by (a) parsing and correlating the call trace data to provide the structured data and (b) processing the device metrics from multiple UEs and geo-binning them based on location;
analyzing the structured data in the interference matrix to determine interferences between cells; and
displaying information about the determined interferences.

2. The method of claim 1, wherein the call trace data or the device metrics include measurement data, physical information, and configuration management data.

3. The method of claim 2, wherein the physical information includes handover information and the configuration management data includes topology data.

4. The method of claim 1, wherein the location is based on a reported location within the device metrics, and the geo-binning is a grouping of individual device metrics during a period of time and based on a fixed bin size.

5. The method of claim 1, wherein the determined interferences are Physical layer Cell Identifier (PCI) clashes.

6. The method of claim 5, wherein the PCI clashes include at least one of:
a PCI collision between serving cell and reported cell;
a PCI confusion between any reported cell of the same serving cell;
a PCI confusion between a serving cell and any second order reported cell;
a PCI confusion between any reported cell of a specific serving cell and any other second order reported cell;
a PCI confusion between two serving cells with a common reported cell; and
a PCI collision between two cells serving two or more distinct devices located with a fixed distance from each other.

7. The method of claim 1, wherein the parsing and correlating or the processing includes classifying the cells by technology and by carrier.

8. The method of claim 1, wherein the steps further include:
retrieving at least one planning rule threshold, wherein the planning rule threshold is one of a percentage of overlapping, a minimum amount of data points, a minimum required Reference Signal Received Power (RSRP) level of the reported cell, a minimum handover success rate for a neighbor cell and a maximum number of handover attempts in a measurement period.

9. The method of claim 8, wherein the steps further include:
identifying a cell from the telecommunications network to be a neighboring cell to another cell of the telecommunications network using the planning rule threshold and providing a neighbor addition report to the telecommunications network including information about the identified cell.

10. The method of claim 8, wherein the steps further include:
determining a cell from the telecommunications network to be falsely identified as a neighboring cell to another cell of the telecommunications network using metrics of the interference matrix and providing a neighbor deletion report to the telecommunications network including information about the determined cell, wherein the falsely identified cell has less measurements than the minimum expected measurements.

11. The method of claim 10, wherein the falsely identified cell does not meet the minimum handover success rate for a neighbor cell.

12. The method of claim 1, wherein the steps further include:
identifying problematic cells within the network, wherein the problematic cells are at least one of a serving cell with a high number of associated interferences, a serving cell with poor Reference Signal Received Power (RSRP) difference (lack of dominance) and a reported or correlated cell which is causing unnecessary interference.

13. The method of claim 1, wherein the determining interferences includes identifying reported cells with a higher importance using the structured data.

14. The method of claim 13, wherein the identifying includes calculating a footprint overlapping metric using (a) a number of measurement reports in which a reported cell is present for a specific serving cell or (b) a number of device metrics where various cells are present within a reporting period and location bin area.

15. The method a of claim 13, wherein the determining interferences includes comparing magnitudes of a Reference Signal Received Power (RSRP) of each reported cell and serving cell.

16. A non-transitory computer-readable medium comprising instructions for identifying interferences in a telecommunications network having at least one serving cell and at least one reported cell, the instructions, when executed, cause one or more processors to implement steps of:
retrieving data sources including one or more of (a) call trace data from the telecommunications network and (b) device metrics from multiple user equipment (UEs) connected to a telecommunications network;
processing the data sources to form an interference matrix with structured data that is vendor and device agnostic by (a) parsing and correlating the call trace data to provide the structured data and (b) processing the device metrics from multiple UEs and geo-binning them based on location;
analyzing the structured data in the interference matrix to determine interferences between cells; and
displaying information about the determined interferences.

17. The non-transitory computer-readable medium of claim 16, wherein the steps further include:
retrieving at least one planning rule threshold, wherein the planning rule threshold is one of a percentage of overlapping, a minimum amount of data points, a minimum required Reference Signal Received Power (RSRP) level of the reported cell, a minimum handover success rate for a neighbor cell and a maximum number of handover attempts in a measurement period.

18. The non-transitory computer-readable medium of claim 16, wherein the steps further include:
identifying problematic cells within the network, wherein the problematic cells are at least one of a serving cell with a high number of associated interferences, a serving cell with poor Reference Signal Received Power (RSRP) difference (lack of dominance) and a reported or correlated cell which is causing unnecessary interference.

19. An apparatus comprising:
one or more processors; and
memory storing instructions for identifying interferences in a telecommunications network having at least one serving cell and at least one reported cell, the instructions, when executed cause the one or more processors to:
retrieve data sources including one or more of (a) call trace data from the telecommunications network and (b) device metrics from multiple user equipment (UEs) connected to a telecommunications network;
process the data sources to form an interference matrix with structured data that is vendor and device agnostic by (a) parsing and correlating the call trace data to provide the structured data and (b) processing the device metrics from multiple UEs and geo-binning them based on location;
analyze the structured data in the interference matrix to determine interferences between cells; and
cause a display of information about the determined interferences.

20. The apparatus of claim 19, wherein the instructions, when executed cause the one or more processors to:
retrieve at least one planning rule threshold, wherein the planning rule threshold is one of a percentage of overlapping, a minimum amount of data points, a minimum required Reference Signal Received Power (RSRP) level of the reported cell, a minimum handover success rate for a neighbor cell and a maximum number of handover attempts in a measurement period.
